(19) United States
(12) Patent Application Publication
(10) Pub. No.: US 2016/0003778 A1
(43) Pub. Date: Jan. 7, 2016

(54) OBSTACLE DETECTION DEVICE

(71) Applicants: Koji IBATA, Chiyoda-ku, Tokyo (JP); Tomonori KIMURA, Chiyoda-ku, Tokyo (JP); Hiroaki MIYASHITA, Chiyoda-ku, Tokyo (JP); Satoru INOUE, Chiyoda-ku, Tokyo (JP); MITSUBISHI ELECTRIC CORPORATION, Tokyo (JP)

(72) Inventors: Koji IBATA, Tokyo (JP); Tomonori KIMURA, Tokyo (JP); Hiroaki MIYASHITA, Tokyo (JP); Satoru INOUE, Tokyo (JP)

(73) Assignee: MITSUBISHI ELECTRIC CORPORATION, Tokyo (JP)

(21) Appl. No.: 14/768,083

(22) PCT Filed: Mar. 6, 2013
(86) PCT No.: PCT/JP2013/056140

§ 371 Date: Aug. 14, 2015

(51) Int. Cl. G01N 29/09

(52) U.S. Cl. CPC G01N 29/09; G01N 2291/018

(57) ABSTRACT

An obstacle detection device includes an air-coupled ultrasonic wave sensor 2 mounted into a penetrating hole 11 of a mounting member 1 with an emitting surface 21a being oriented towards outside the obstacle detection device, and an acoustic matching layer 3 fixed to the emitting surface 21a, to achieve matching between the acoustic impedance of the air-coupled ultrasonic wave sensor 2 and that of the air, in which microcapsules 31 are added to the same material as that of the mounting member 1.

### FIELD OF THE INVENTION

The present invention relates to an obstacle detection device that is mounted to, for example, the bumper of a vehicle, such as a car, and that detects an obstacle located in an area surrounding the vehicle.

### BACKGROUND OF THE INVENTION

An air-coupled ultrasonic wave sensor that uses a piezoelectric element transmits a ultrasonic wave into the air therefrom, and this ultrasonic wave is reflected by an obstacle or the like and then propagates through the air. By receiving this reflected ultrasonic wave, the air-coupled ultrasonic wave sensor detects the obstacle or the like. By mounting this air-coupled ultrasonic wave sensor to a wall member, such as the bumper of a vehicle such as a car, via a penetrating hole formed in the wall member, the air-coupled ultrasonic wave sensor is used as an obstacle detection device that detects an obstacle located in an area surrounding the vehicle (for example, refer to patent reference 1). Conventionally, the air-coupled ultrasonic wave sensor used for an obstacle detection device is mounted in a state in which its emitting surface is exposed to outside the obstacle detection device from the penetrating hole, in such a way as to be able to perform transmission and reception of the ultrasonic wave.

### RELATED ART DOCUMENT

### Patent Reference

Patent reference 1: Japanese Unexamined Patent Application Publication No. 2006-298010

### SUMMARY OF THE INVENTION

### Problems to be Solved by the Invention

In the conventional obstacle detection device disclosed in patent reference 1, the air-coupled ultrasonic wave sensor is mounted in a state in which its emitting surface is exposed to outside the obstacle detection device, as mentioned above. In contrast, the bumper of a vehicle is typically made from a resin material and the case of the air-coupled ultrasonic wave sensor is made from a metallic material. Therefore, because the emitting surface of the air-coupled ultrasonic wave sensor can be recognized from outside the sensor when the emitting surface of the air-coupled ultrasonic wave sensor is mounted to the bumper in a state in which the emitting surface is exposed to outside the obstacle detection device, as mentioned above, a problem occurs in the designability.

A further problem is that because when the same paint is disposed on the bumper and on the emitting surface of the air-coupled ultrasonic wave sensor, both the materials of the bumper and the emitting surface differ from each other, their color developments differ from each other and hence the designability degrades.

In contrast, when in consideration of the designability, no penetrating hole is formed in the bumper and the air-coupled ultrasonic wave sensor is disposed in such a way that its emitting surface is not exposed to outside the obstacle detection device, the sensitivity of the air-coupled ultrasonic wave sensor degrades remarkably.

The present invention is made in order to solve the above-mentioned problems, and it is therefore an object of the present invention to provide an obstacle detection device that can improve its sensor sensitivity and can improve its designability.

### Means for Solving the Problem

In accordance with the present invention, there is provided an obstacle detection device including: an air-coupled ultrasonic wave sensor having an ultrasonic transducer on an inner side of a bottom surface of a metallic case, and an emitting surface on an outer side of the bottom surface of the metallic case; and an acoustic matching layer placed and mounted in such a way that a surface thereof is fixed to the emitting surface and another surface thereof is exposed to outside the obstacle detection device via a penetrating hole of a mounting member, in which microcapsules are added to the same material as that of the mounting member.

### Advantages of the Invention

Because the obstacle detection device in accordance with the present invention is configured as above, the sensor sensitivity can be improved and the designability can be improved.

### BRIEF DESCRIPTION OF THE FIGURES

FIG. 1 is a schematic diagram showing the configuration of an obstacle detection device in accordance with Embodiment 1 of the present invention;

FIG. 2 is a schematic diagram showing the configuration of an air-coupled ultrasonic wave sensor to which an acoustic matching layer in Embodiment 1 of the present invention is fixed;

FIG. 3 is a schematic diagram showing the configuration of an obstacle detection device in accordance with Embodiment 3 of the present invention; and

FIG. 4 is a schematic diagram showing the configuration of an obstacle detection device in accordance with Embodiment 4 of the present invention.

### EMBODIMENTS OF THE INVENTION

Hereafter, the preferred embodiments of the present invention will be explained in detail with reference to the drawings. In each of the embodiments which will be described below, a case in which an air-coupled ultrasonic wave sensor 2 is mounted to a vehicle will be explained as an example.

### Embodiment 1

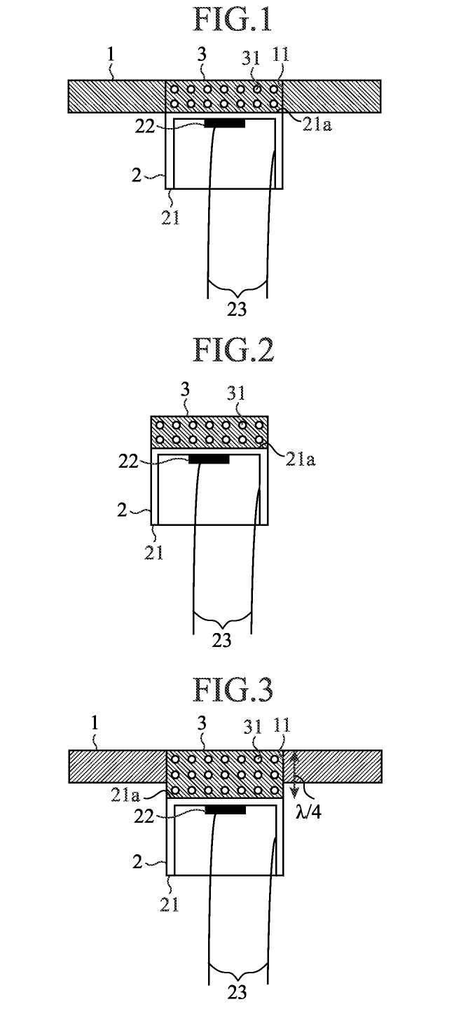

FIG. 1 is a schematic diagram showing the configuration of an obstacle detection device in accordance with Embodiment 1 of the present invention, and FIG. 2 is a schematic diagram showing the configuration of an air-coupled ultrasonic wave sensor 2 to which an acoustic matching layer 3 is fixed.

The obstacle detection device is configured with the air-coupled ultrasonic wave sensor 2 and the acoustic matching layer 3 which are mounted into a penetrating hole 11 of a mounting member 1, as shown in FIG. 1.

The mounting member 1 is the bumper, the body, or the like of a vehicle, such as a car, and is made from a synthetic resin material such as a polypropylene resin.

The air-coupled ultrasonic wave sensor 2 detects an obstacle located in an area surrounding the vehicle, and is mounted into the penetrating hole 11 of the mounting member 1 with an emitting surface 21a thereof being oriented towards outside the obstacle detection device. This air-coupled ultrasonic wave sensor 2 is configured with a case 21 which is made from a metallic material, such as aluminum, an ultrasonic transducer 22, and lead wires 23, as shown in FIG. 2.

The acoustic matching layer 3 is made from the same material as that of the mounting member 1, and is the one in which a predetermined amount of glass and microcapsules 31, such as organic substances, are added and is fixed to the emitting surface 21a of the air-coupled ultrasonic sensor 2. This acoustic matching layer 3 is intended for achieving matching between the acoustic impedance of the air-coupled ultrasonic wave sensor 2 and that of the air.

And, in accordance with Embodiment 1, as shown in equation (1), the added amount of the microcapsules 31 is determined in such a way that the acoustic impedance of the acoustic matching layer 3 has a value intermediate between the acoustic impedance of the air-coupled ultrasonic wave sensor 2 and that of the air.

Zₛ>Zₘ>Zₐ (1)

Zₛ denotes the acoustic impedance of the air-coupled ultrasonic wave sensor 2, Zₐ denotes the acoustic impedance of the air, and Zₘ denotes the acoustic impedance of the acoustic matching layer 3.

The air-coupled ultrasonic wave sensor 2 of the obstacle detection device configured as above applies a voltage to the ultrasonic transducer 22 via the lead wires 23, thereby exciting an ultrasonic wave and emitting this ultrasonic wave into the air. The ultrasonic wave emitted from the air-coupled ultrasonic wave sensor 2 is reflected by an obstacle, and is received by the air-coupled ultrasonic wave sensor 2. As a result, the obstacle can be detected. The obstacle detection device is mounted to the front, the rear, or a corner of the vehicle so as to be able to detect an obstacle located in an area surrounding the vehicle.

Because the acoustic matching layer 3 is disposed on the emitting surface 21a of the air-coupled ultrasonic wave sensor 2, matching between the acoustic impedance of the air-coupled ultrasonic wave sensor 2 and that of the air can be achieved. As a result, because the reflection of the ultrasonic wave at a boundary between the air-coupled ultrasonic wave sensor 2 and the acoustic matching layer 3, and at a boundary between the acoustic matching layer 3 and the air can be suppressed and therefore the propagation efficiency of the ultrasonic wave can be improved, the sensitivity of the air-coupled ultrasonic wave sensor 2 is improved.

In addition, the acoustic matching layer 3 fixed to the emitting surface 21a of the air-coupled ultrasonic wave sensor 2 is placed in such a way as to be exposed to outside the obstacle detection device from the penetrating hole 11 of the mounting member 1. Because the acoustic matching layer 3 is made from the same material as that of the mounting member 1, the air-coupled ultrasonic wave sensor 2 is hard to recognize and hence the designability is improved.

As mentioned above, because the obstacle detection device in accordance with this Embodiment 1 is configured in such a way that the acoustic matching layer 3 which is made from the same material as that of the mounting member 1 is mounted to the mounting member 1 with being fixed to the emitting surface 21a of the air-coupled ultrasonic wave sensor 2, the sensor sensitivity can be improved and the designability can be improved.

### Embodiment 2

In Embodiment 2, the requirement on the determination of the added amount of the microcapsules 31 is changed. The configuration of the obstacle detection device in accordance with Embodiment 2 is the same as the configuration shown in FIG. 1, and the explanation of the configuration will be omitted hereafter.

In the obstacle detection device in accordance with Embodiment 2, as shown in equation (2), the added amount of the microcapsules 31 is determined in such a way that the acoustic impedance of the acoustic matching layer 3 has a value which is approximately the square root of the product of the acoustic impedance of the air-coupled ultrasonic wave sensor 2 and that of the air.

Zₘ=\sqrt{ZₐZₛ} (2)

By determining the acoustic impedance of the acoustic matching layer 3 in this way, the transmitting and receiving efficiency of the ultrasonic wave is improved and hence the sensitivity of the air-coupled ultrasonic wave sensor 2 is improved.

The operation of the obstacle detection device in accordance with Embodiment 2 is the same as that in accordance with Embodiment 1, and the explanation of the operation will be omitted hereafter.

As mentioned above, the obstacle detection device in accordance with this Embodiment 2 can further improve the sensor sensitivity as compared with Embodiment 1 by determining the added amount of the microcapsules 31 of the acoustic matching layer 3 in such a way that the amount satisfies the relation given by the equation (2).

### Embodiment 3

In Embodiment 3, a case of determining the thickness of the acoustic matching layer 3 on a predetermined condition will be shown.

FIG. 3 is a schematic diagram showing the configuration of an obstacle detection device in accordance with Embodiment 3 of the present invention. The obstacle detection device in accordance with Embodiment 3 shown in FIG. 3 is the same as the obstacle detection device in accordance with Embodiment 1 shown in FIG. 1 with the exception that the thickness of the acoustic matching layer 3 is changed, and only the different portion will be explained.

The obstacle detection device in accordance with Embodiment 3 is configured in such a way that, when the wavelength of the ultrasonic wave excited by the air-coupled ultrasonic wave sensor 2 is denoted by A, the thickness of the acoustic matching layer 3 is approximately λ/4. By adjusting the thickness of the acoustic matching layer 3 in this way, the transmitting and receiving efficiency of the ultrasonic wave is improved and hence the sensitivity of the air-coupled ultrasonic wave sensor 2 is improved.

The operation of the obstacle detection device in accordance with Embodiment 3 is the same as that in accordance with Embodiment 1, and the explanation of the operation will be omitted hereafter.

As mentioned above, in accordance with this Embodiment 3, even though the obstacle detection device is configured in such a way that the thickness of the acoustic matching layer 3 is approximately one-quarter of the wavelength A of the ultrasonic wave, the same advantages as those provided by Embodiment 1 can be provided.

### Embodiment 4

In Embodiment 4, a case in which a paint 4 is disposed on a surface of an obstacle detection device will be shown.

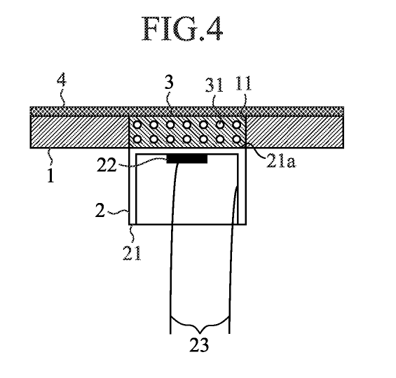

FIG. 4 is a schematic diagram showing the configuration of the obstacle detection device in accordance with Embodiment 4 of the present invention. The obstacle detection device in accordance with Embodiment 4 shown in FIG. 4 is the same as the obstacle detection device in accordance with Embodiment 1 shown in FIG. 1 with the exception that the paint 4 is disposed on the surface of the obstacle detection device, and only the different portion will be explained.

In the obstacle detection device in accordance with Embodiment 4, the same paint 4 is disposed on a surface of the mounting member 1, and on a surface of the acoustic matching layer 3. The air-coupled ultrasonic wave sensor 2 is positioned in such a way that the surface of the acoustic matching layer 3 is flush with the surface of the mounting member 1.

In this embodiment, because the mounting member 1 and the acoustic matching layer 3 are made from the same material, when the same paint 4 is disposed on them, no difference does not occur in their color developments, and the visibility from outside the obstacle detection device can be reduced and hence the designability can be improved. Further, because the paint 4 can be disposed after the air-coupled ultrasonic wave sensor 2 and the acoustic matching layer 3 are mounted to the mounting member 1, the cost of the paint 4 can be reduced.

In addition, the air-coupled ultrasonic wave sensor 2 is positioned in such a way that the surface of the acoustic matching layer 3 is a part of the surface of the mounting member 1. By making the mounting member 1 flush with the acoustic matching layer 3, no level difference occurs at the boundary between them and the visibility from outside the obstacle detection device can be further reduced, and non-uniformity in the paint application and so on can be prevented from occurring when the paint 4 is disposed, and hence the designability can be improved.

The operation of the obstacle detection device in accordance with Embodiment 3 is the same as that in accordance with Embodiment 1, and the explanation of the operation will be omitted hereafter.

As mentioned above, because the obstacle detection device in accordance with this Embodiment 4 is configured in such a way that the same paint 4 is disposed on the surface of the mounting member 1 and on the surface of the acoustic matching layer 3, the designability can be further improved as compared with Embodiment 1.

While the invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

The obstacle detection device in accordance with the present invention can improve the sensor sensitivity and can improve the designability, and is suitable for use in an obstacle detection device or the like that is mounted to the bumper of a vehicle, such as a car, and that detects an obstacle located in an area surrounding the vehicle.

### EXPLANATIONS OF REFERENCE NUMERALS

1 mounting member, 2 air-coupled ultrasonic wave sensor, 3 acoustic matching layer, 4 paint, 11 penetrating hole, 21a emitting surface, 21 case, 22 ultrasonic transducer, 23 lead wire, and 31 microcapsule.

1. An obstacle detection device comprising:
an air-coupled ultrasonic wave sensor having an ultrasonic transducer on an inner side of a bottom surface of a metallic case, and an emitting surface on an outer side of the bottom surface of said metallic case; and
an acoustic matching layer placed and mounted in such a way that a surface thereof is fixed to said emitting surface and another surface thereof is exposed to outside said obstacle detection device via a penetrating hole of a mounting member, in which microcapsules are added to a material which is same as that of said mounting member.

2. The obstacle detection device according to claim 1, wherein an added amount of said microcapsules is a one that makes an acoustic impedance of said acoustic matching layer have a value intermediate between the acoustic impedance of said air-coupled ultrasonic wave sensor and that of the air.

3. The obstacle detection device according to claim 2, wherein the added amount of said microcapsules is a one that makes the acoustic impedance of said acoustic matching layer have a value which is approximately a square root of a product of the acoustic impedance of said air-coupled ultrasonic wave sensor and that of the air.

4. The obstacle detection device according to claim 1, wherein said acoustic matching layer has a thickness which is approximately one-quarter of a wavelength of an ultrasonic wave excited by said air-coupled ultrasonic wave sensor.

5. The obstacle detection device according to claim 1, wherein a surface of said acoustic matching layer is flush with a surface of said mounting member.

6. The obstacle detection device according to claim 1, wherein on a surface of said acoustic matching layer which is exposed to outside said obstacle detection device via the penetrating hole of said mounting member, same paint as that disposed on a surface of said mounting member is disposed.

7. The obstacle detection device according to claim 1, wherein said mounting member is a bumper or a body of a vehicle.
